(19) United States
(12) Patent Application Publication
(10) Pub. No.: US 2007/0056409 A1
(43) Pub. Date: Mar. 15, 2007

(54) Radius wrench

(76) Inventor: Lance A. Dickey, W. Jordan, UT (US)

Correspondence Address: Galasso & Associates, LP, P.O. Box 26503, Austin, TX, 78755-0503, US

(21) Appl. No.: 11/507,759

(22) Filed: Aug. 22, 2006

Related U.S. Application Data
(60) Provisional application No. 60/715,444, filed on Sep. 9, 2005.

(51) Int. Cl. B25B 17/00

(52) U.S. Cl. 81/57.3

(57) ABSTRACT

Radius Wrench is a curved wrench used to access hard to reach areas. Radius Wrench utilizes a set of gears as well as the standard ratchet or air assisted tools such as the air gun and air ratchet. Through the use of gears, the ratchet is placed on one end of the wrench and the other end is placed onto the fastener that needs to be removed or tightened. Radius Wrench is easy to operate and prevents injuries to the hands from difficult to reach locations.

### CROSS REFERENCE TO RELATED APPLICATIONS

This Non-Provisional Patent Application claims priority to U.S. Provisional Patent Application No. 60/715,444 entitled “Radius Wrench” filed on Sep. 9, 2005.

### FIELD OF THE DISCLOSURE

The disclosures made herein relate generally to the automobile, industrial and home improvement industries. The invention discussed herein is in the general classification of specialized wrenches.

### BACKGROUND

Craftsmen and tradesmen use a variety of tools to complete their labor. Some of the tools are specific to a given skill or trade. For example, plumbers make use of pipe wrenches while electricians use wire connectors. Other tools are common to most skilled craftsmen. Screwdrivers and hammers are tools that are employed on almost all job sites.

The wrench is perhaps the most versatile of all tools. It is manufactured in a wide range of models and sizes. All branches of the construction, building, and installation industry make use of wrenches. Automotive mechanics also utilize many wrench models as they repair or maintain a motor vehicle. Unfortunately, using a wrench can often be challenging when a fastener is located in a difficult to reach location. A variety of wrench extensions and socket wrenches have been invented, but even these devices do not allow easy access to all locations. Quite frequently it is either impossible or extremely expensive to access remote locations with traditional wrenches or wrench extensions.

Hence, there is a need in the art for an easy to use, inexpensive and effective device that will allow a user to access difficult to reach fasteners without having to completely disassemble an apparatus or risk injury to the user's hands.

### SUMMARY OF THE DISCLOSURE

Radius Wrench consists of a curved or pivoting housing with gears within the housing connected together with the use of rivets. The gears rotate upon these rivets from one end of the wrench to the other. At one end of the wrench there is a drive socket gear for the placement of a ratchet or the like. On the other end of the wrench is a fastener gear to be placed over the fastener for tightening or loosening.

The principal object of this invention is to provide a device that allows easy access to difficult to reach fasteners.

Another object of this invention is to provide a device that provides the necessary torque for loosening or tightening a fastener without the need for a large space to turn a wrench.

Another object of this invention is to provide an affordable device for reaching various sized fasteners without injuring a user's hands.

Yet another object of this invention is to provide an easy to use, adjustable device for reaching a fastener without the need for wrench extensions or other cumbersome devices.

### BRIEF DESCRIPTION OF THE DRAWINGS

FIG. 1 depicts a perspective view of the preferred embodiment of the invention.

FIG. 2 depicts a cross-sectional view of the preferred embodiment of the invention cut along the line A-A of FIG. 1.

FIG. 3 depicts a perspective view of an alternative embodiment of the invention.

### DETAILED DESCRIPTION OF THE DRAWINGS

The preferred embodiment of Radius Wrench is comprised of at least some of the following: a curved two-piece housing containing gears, rivets for connecting the two-piece housing and permitting rotation of the gears, a drive socket gear for the placement of a ratchet or the like on one end of the curved two-piece housing, and a fastener gear on the opposite end of the two-piece housing.

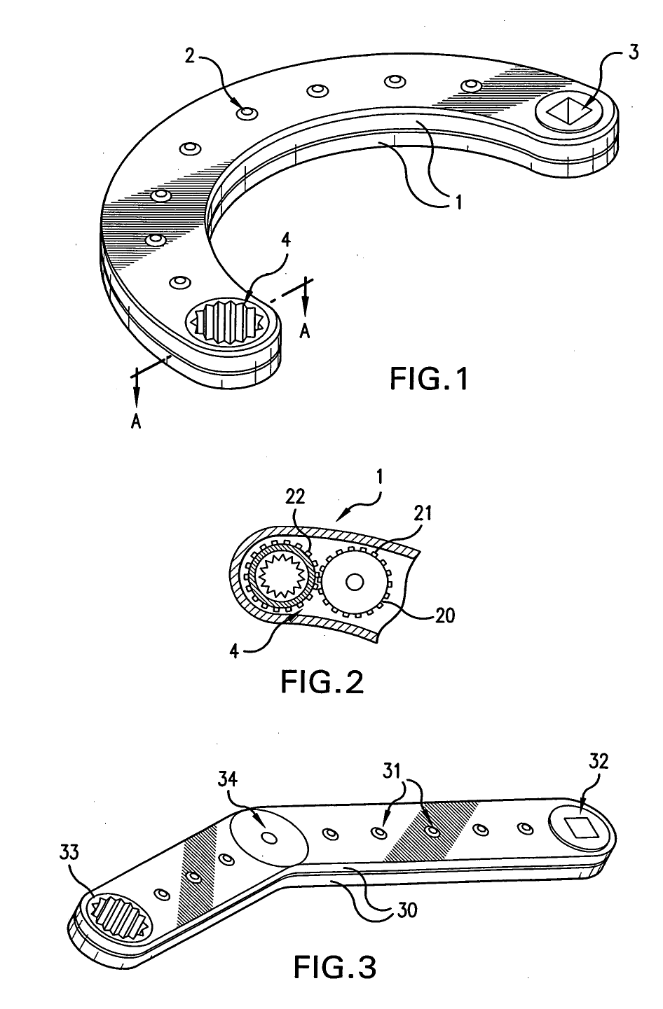

In the preferred embodiment of the invention, shown in FIG. 1, a two-piece housing 1 shaped like a semi-circle covers a series of bull gears (not pictured). The housing 1 is made of steel in this preferred embodiment though it could be made of a variety of materials. The housing 1 is approximately eight inches in length though a variety of sizes can be used with the preferred embodiment. Rivets 2 connect the two halves of the housing 1 and provide a pivot or rotating device for the series of bull gears. The rivets 2 are made of stainless steel to prevent rusting.

The series of bull gears extend the length of the housing 1. At one end of the housing 1 is a drive socket gear 3 for the placement of the ratchet or pneumatic tool. On the other end of the housing 1 is the fastener gear 4, which ranges in size from one-fourth of an inch to three-fourths of an inch, though other sizes could be utilized.

FIG. 2 depicts a cross-sectional view of the preferred embodiment of the invention cut along the Line A-A of FIG. 1. This view shows in detail the fastener gear 4 along with one of the series of bull gears 20 that extend along the length of the housing 1. The bull gear teeth 21 engage the fastener gear teeth 22 to provide the necessary torque for fastening or unfastening a fastener.

FIG. 3 is a perspective view of an alternative embodiment of the present invention. This alternative embodiment allows a user to choose a variety of shapes for the wrench. This allows the user to customize the wrench for a given project. A two-piece housing 30 covers a series of bull gears (not pictured) as with the preferred embodiment of the invention. The housing 30 is preferably made of steel in this embodiment as well. The housing 30 is approximately eight inches in length though a variety of sizes can be utilized. Rivets 31 connect the two halves of the housing 30 and provide a pivot or rotating device for the series of bull gears. The rivets 31 are made of stainless steel to prevent rusting in this embodiment as well. In this embodiment, however, one of the bull gears is located at a point in the housing that serves as a pivot point 34 for the wrench. The pivot point 34 allows the housing 30 to take on many shapes for use with a variety of projects.

The series of bull gears extend the length of the housing 30. At one end of the housing 30 is a drive socket gear 32 for the placement of the ratchet or pneumatic tool. On the other end of the housing 30 is the fastener gear 33, which ranges in size from one-fourth of an inch to three-fourths of an inch, though other sizes could be utilized.

To use Radius Wrench, a user simply places the fastener gear over the fastener to be removed or tightened. The user then uses the drive socket gear to transfer power from one end of the wrench to the other through the series of gears located within the housing. The teeth of the drive socket gear turn the teeth of the first bull gear that turns the teeth of the second bull gear as so on. This continues until the last bull gear turns the teeth of the fastener gear.

The components of Radius Wrench may vary widely but will likely use metal components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

It should be obvious that the components of the present invention can be of various shapes and sizes. It should also be obvious that the components of the invention can be made of different types of metals or other suitable materials and can be of any color. It should further be obvious that although the present invention is ordinarily used for home improvement, it could be used to accomplish a variety of tasks.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A wrench comprising:
(a) a plurality of gears within a housing;
(b) a plurality of rivets that provide a series of pivots for rotation of the plurality of gears;
(c) a drive socket gear on one end of the housing; and
(d) a fastener gear on the end of the housing opposite the drive socket gear;

2. The wrench of claim 1 wherein the housing is made of two-pieces connected with the plurality of rivets.

3. The wrench of claim 1 wherein the housing is semi-circular in shape.

4. The wrench of claim 1 wherein the housing has a pivot point.

5. The wrench of claim 1 wherein the housing is made of steel.

6. The wrench of claim 1 wherein the rivets are made of stainless steel.

7. The wrench of claim 1 wherein the plurality of gears are bull gears.

8. A wrench comprising:
(a) a plurality of bull gears within a two-piece housing that is semi-circular and made of steel;
(b) a plurality of rivets made of stainless steel that connect the two-piece housing and provide a series of pivots for rotation of the plurality of bull gears;
(c) a drive socket gear on one end of the two-piece housing; and
(d) a fastener gear on the end of the two-piece housing opposite the drive socket gear.
